(19) United States
(12) Patent Application Publication
(10) Pub. No.: US 2012/0107442 A1
(43) Pub. Date: May 3, 2012

(54) CUSTOMIZABLE MOLD SYSTEM

(76) Inventor: Glenn Starkey, Wauconda, IL (US)

(21) Appl. No.: 13/282,710

(22) Filed: Oct. 27, 2011

Related U.S. Application Data
(60) Provisional application No. 61/407,074, filed on Oct. 27, 2010.

(51) Int. Cl. B29C 33/20; B23P 11/00; B29C 33/02

(52) U.S. Cl. 425/451.9; 29/428

(57) ABSTRACT

A customizable mold system for creating a custom mold by selecting from a plurality of pre-engineered mold bases and plates. Where the plurality of pre-engineered mold bases and plates provide various options for the custom mold including: a number of cavities; a size of the cavities; a type of coring method; and a type of gating method, for a selected global standard (US, DIN, JIS).

### BACKGROUND OF THE INVENTION

1. Field of the Invention

The present invention relates to a system for creating a customizable mold by selecting from a plurality of pre-engineered mold bases and/or plates.

2. Discussion of Related Art

Custom tooling, such as injection molds, typically require long lead times and costly construction. However, even custom molds often have similar basic designs and numerous overlapping parts and configurations. Leveraging such basic designs and common components may result in an inventoried mold base capable of numerous off-the-shelf configurations thereby cutting down costs and lead times. Thus, there is a need for a customizable mold system that enables a mold builder to insert the desired cores and cavities into a production ready mold base.

### SUMMARY OF THE INVENTION

According to a preferred embodiment of this invention, a pre-engineered kit-style mold system is contemplated that includes a configurable mold base having a series of interchangeable plates and/or optional components and features. The mold base is preferably reusable and/or reconfigurable into additional desired configurations following use in a particular project and/or molding run. For ease of explanation, the description of this invention will be focused on a pre-engineered kit-style mold system for creating a mold for manufacturing caps and containers. However, it is understood that the teachings of this invention can be used in the manufacture of various components, including, but not limited to, toy parts, tools, toothbrushes and car parts.

The term “mold” as used herein refers to both mold bases or frames sold by mold manufacturers without the final cores and/or cavities therein, as well as to molds that include cores and/or cavities. Thus, it is contemplated that a mold base or frame may be sold prior to an actual cavity being formed. Similarly, although plastic injection molds are shown and described by example, the system as described may be used in connection with any reciprocating, molding or cycling manufacturing equipment including but not limited to blow molding, stamping, die casting, etc.

According to an embodiment of this invention, the mold includes a first mold half and a second mold half. The first mold half and the second mold half preferably reciprocate relative to each other from a closed position to an open position. In the closed position, the first mold half and the second mold half mate to each other to form a molded product, wherein one of the first mold half and the second mold half contain a core and a corresponding cavity, respectively. While the open position allows for ejection of the molded component. In a preferred embodiment, the first mold half includes a top clamp plate, an X-plate and an A-plate. The second mold half includes a B-plate, an action plate and a bottom clamp plate. In an alternative embodiment, any of the top clamp plate, the X-plate, the A-plate, the B-plate, the action plate and the bottom clamp plate may be omitted and/or additional intermediary plates, including a hot runner plate, may be added to the mold in order to create the molded product. In a preferred embodiment, at least one of the plates include a cavity insert and/or a core insert to impart features onto the molded component, including, but not limited to, a surface texture, a shape and/or a coring style.

A custom mold may be created from the pre-engineered kit-style mold system using the following steps. A component size is first selected. In an embodiment of this invention, the pre-engineered kit-style mold system includes plates that provide for a small outer diameter cap size and a large outer diameter cap size. Second, a gating option is selected. In an embodiment of this invention, the pre-engineered kit-style mold system includes various gating options including a three plate, a hot runner and a sub-gate. The hot runner gating option may further include a valve gate option and a top gate option. Third, a coring style is selected. In an embodiment of this invention, the coring style may be selected from dovetail, jump thread and unscrewing. Fourth, a number of cavities is selected. In an embodiment of this invention, the system includes plates with various cavitation options including 4, 8, 16 and 24 cavities. In an alternative embodiment, any number of cavities may be selected. Fifth, a mold base style is selected. In an embodiment of this invention, the system includes plates with various mold base styles including a European standard (DIN), a U.S. standard (US/Inch) and a Japanese standard (JIS).

The mold system as described is preferably usable in connection with a standardized approach to molding and monitoring that includes standardized tooling and components, standardized maintenance practices, standardized performance review and optimized part design based upon use of the mold system as described.

The standardization of the mold systems described herein avoids the repetitive and time consuming process required of mold builders to create a custom mold. Instead, a builder or molder merely specifies the configurations described above and the desired mold is available off-the-shelf and pre-configured as desired.

According to one preferred embodiment, the subject mold system is designed to permit interchangeability between various coring styles, for instance, between the dovetail core and the jump thread style molding detail. Preferably, a dovetail action plate and molding specific inserts, such as dovetail core, stripper ring and cavity inserts, are removable and replaceable with those required for a jump thread style. These inserts can be replaced while the tool is still in the molding press thereby saving the time required to set up the mold for the press. As a result, an entirely new mold is not required. According to a preferred embodiment, most or all molding specific components are designed to fit in the same pockets, thereby permitting the same mold and/or mold base to be used, for example, for dovetail or for jump thread style molding. This permits a molder the flexibility of changing between mold styles in a single mold while the mold is in press and ready for operation.

Other features and advantages of the invention will be apparent from the following detailed description taken in conjunction with the attached figures.

### BRIEF DESCRIPTION OF THE DRAWINGS

These and other objects and features of this invention will be better understood from the following detailed description taken in conjunction with the drawings, wherein:

FIG. 1 is a perspective view of a mold according to one embodiment of this invention;

FIG. 2 is a side view of the mold of FIG. 1 in an open position; and

FIG. 3 is a top view of the mold of FIG. 1;

FIG. 4 shows steps for configuration of a mold of this invention;

FIG. 5 shows various coring options;

FIGS. 6a-f show a variety of molds that can be created using the system of this invention;

FIGS. 7a-f show individual plates of a three plate mold that can be created using the system of this invention;

FIGS. 8a-f show a assembly views the three plate mold of FIGS. 7a-f; and

FIG. 9 shows a schematic of the interplay among an electronic mold counter and the mold system of this invention.

### DESCRIPTION OF PREFERRED EMBODIMENTS

In accordance with the present invention, an injection mold or similar actuating manufacturing tool is created by selecting from a collection of pre-engineered mold bases and plates. This eliminates custom mold engineering and reduces variability of mold performance. An existing or newly developed and customer owned tool standard can be implemented into the manufacturing and supply process. Mold bases may be reused for a variety of projects as opposed to conventional systems requiring a single mold for each contemplated molded part or family of parts.

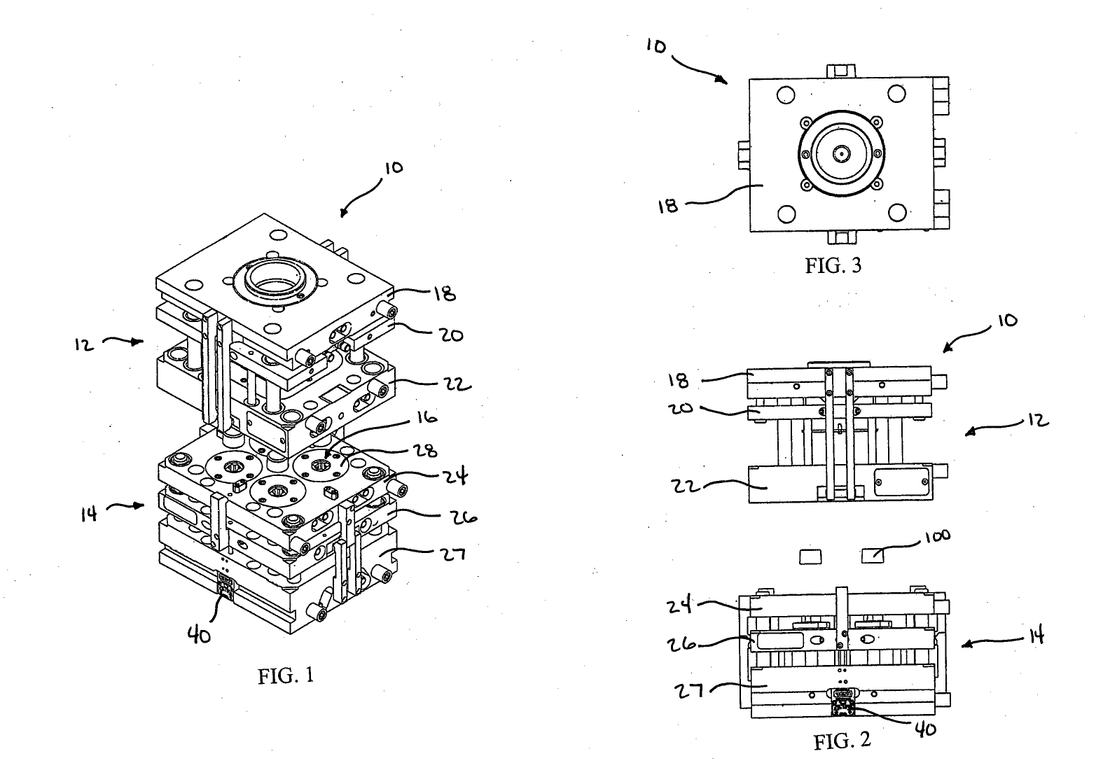

FIGS. 1-3 shows an embodiment of a mold 10 created from components selected from the collection of pre-engineered mold plates. In this embodiment, the mold 10 includes a first mold half 12 and a second mold half 14 that reciprocate relative to each other to form a molded form 16 for manufacturing a product, such as a cap 100. For ease of explanation, the reminder of this description will be directed to the mold 10 for the cap 100. However, it should be understood that a person having skill in the art can utilize the teachings of this invention to create a mold for the manufacture of any type of part including, but not limited to, toy parts, tools, containers and car parts.

In the embodiment of FIGS. 1-3, the first mold half 12 includes a top clamp plate 18, an X-plate 20 and an A-plate 22 and the second mold half 14 includes a B-plate 24, an action plate 26 and a bottom clamp plate 27. In an alternative embodiment of this invention, any of the top clamp plate 18, the X-plate 20, the A-plate 22, the B-plate 24, the action plate 26 and the bottom clamp plate 27 may be omitted and/or additional intermediary plates may be added to the mold 10 in order to create the molded form 16 of a desired product. In a preferred embodiment, at least one of the first mold half 12 and the second mold half 14 accepts a cavity insert and/or a core insert 28, the cavity insert and/or the core insert 28 further customizes a molded component, in this case cap 100, by imparting shapes, surface textures, threads and other features into the molded component.

As described above, the first mold half 12 and the second mold half 14 reciprocate relative to each other to form the molded form in a closed position and to allow for the ejection of the molded component in an open position. In a preferred embodiment and in addition to the movement of the first mold half and the second mold half, at least one of the top clamp plate 18, the X-plate 20, the A-plate 22, the B-plate 24, the action plate 26 and the bottom clamp plate 27 reciprocates relative to at least one other plate to allow for a multiple-stage separation of the plates to facilitate the ejection of the molded component. Additionally, the multiple-stage separation may allow for formation of undercuts and/or formation molded details on the molded component.

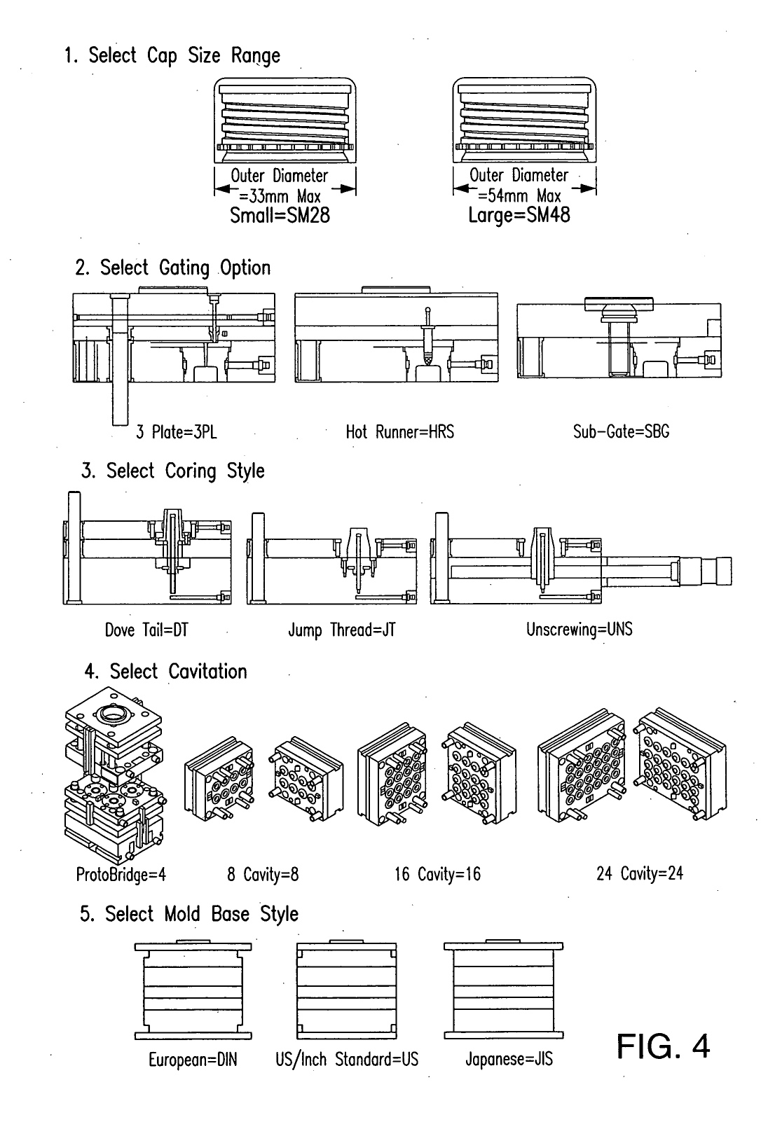

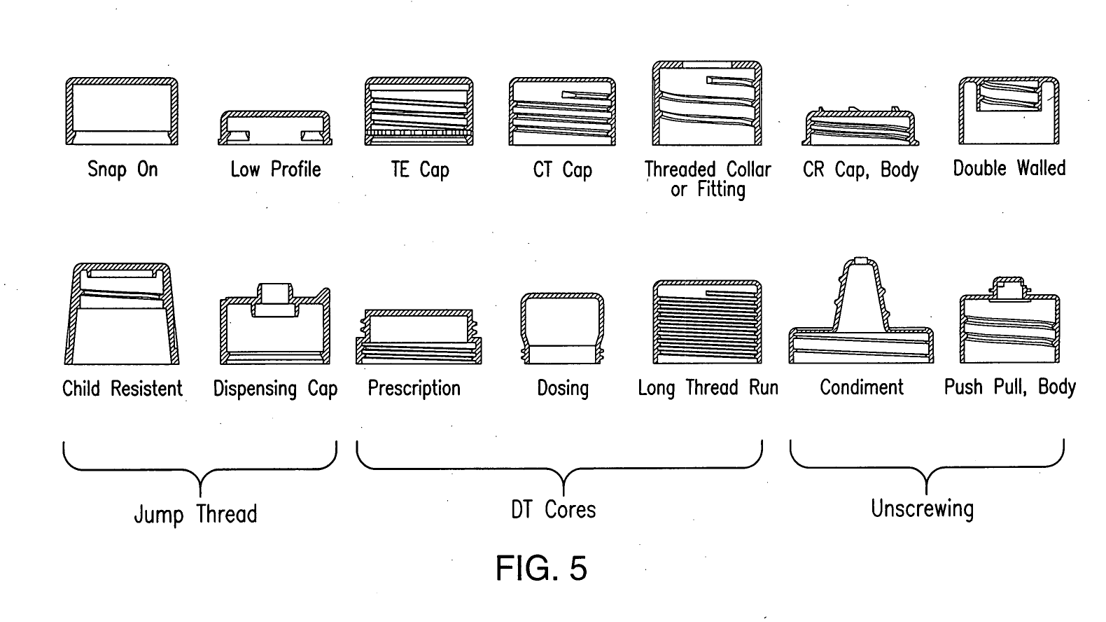

FIG. 4 shows steps for configuration of the mold 10 by selecting from a series of interchangeable and/or optional components and features. First, a cap size range is selected. In this embodiment, the cap size range can be one of small, a maximum outer diameter of 33 mm, and large, a maximum outer diameter of 54 mm. In an alternative embodiment, the cap size may be of any diameter. In another alternative embodiment, the range can be an outer dimension of any type of object sought to be manufactured, for example, but not limited to, a rectangle of any dimensions. Second, a gating option may be selected. In this embodiment, the gating option includes a three plate, a hot runner and a sub-gate. Alternatively, this step may comprise the selection of an outer surface of the object sought to be manufactured. Third, a coring style may be selected. In this embodiment, the coring style may be one of a dovetail, a jump thread and an unscrewing thread. FIG. 5 shows various coring options that a user may specify including jump thread cores, dovetail cores and unscrewing cores. Fourth, a number of cavities may be selected. In this embodiment, the number of cavities may include 4, 8, 16 and 24 cavity options. Intermediate cavity options are available by leaving cavities dormant during production. Alternatively, the number of cavities may include any number sought by a designer. Fifth, a global standard for a mold may be selected. In this embodiment, the mold standard may be selected from a European standard (DIN), U.S. standard (US/Inch) and a Japanese standard (JIS).

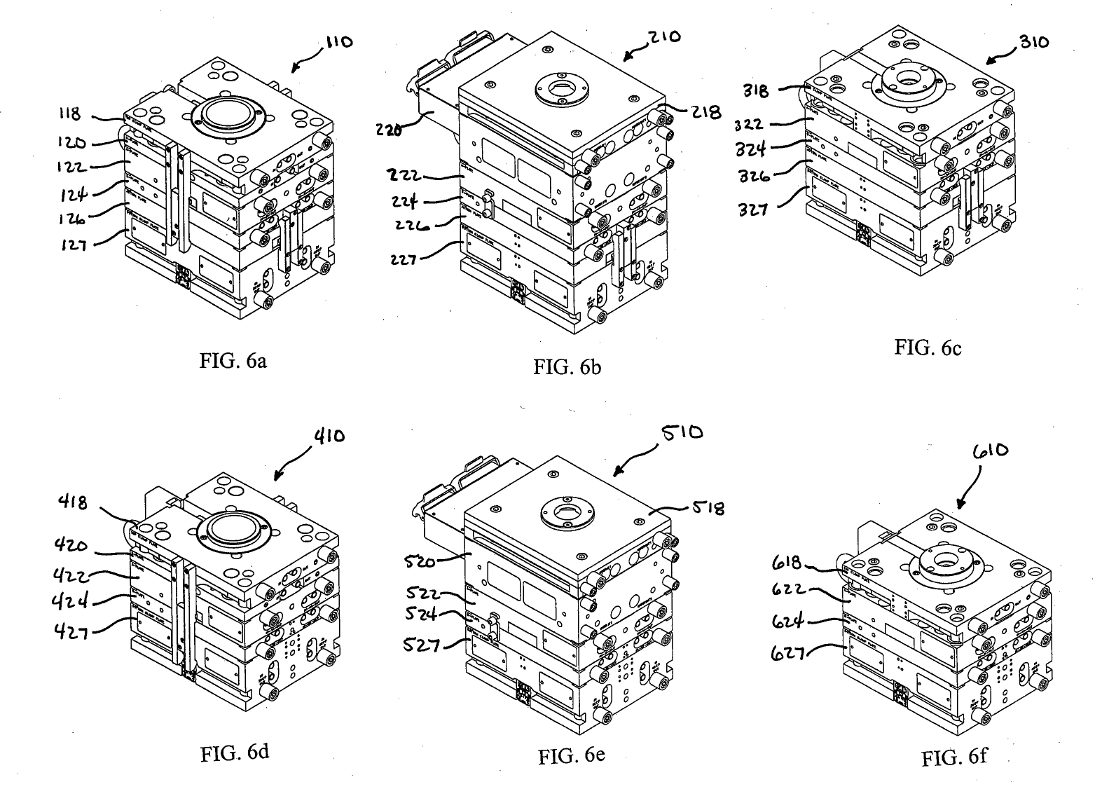

Using the steps described above, a variety of molds may be created including, but not limited to, the examples shown in FIGS. 6a-f. Specifically, FIG. 6a shows a three-plate mold 110 for manufacturing a cap with a dovetail thread. The three-plate mold 110 is a European standard, four cavity mold and includes a top clamp plate 118, an X-plate 120, an A-plate 122, a B-plate 124, an action plate 126 and a bottom clamp plate 127. FIG. 6b shows a hot runner mold 210 for manufacturing a cap with a dovetail thread. The hot runner mold 210 is a European standard, four cavity mold and includes a top clamp plate 218, a hot runner plate 220, an A-plate 222, a B-plate 224, an action plate 226 and a bottom clamp plate 227. FIG. 6c shows a sub-gate mold 310 for manufacturing a cap with a dovetail thread. The sub-gate mold 310 is a European standard, four cavity mold and includes a top clamp plate 318, an A-plate 322, a B-plate 324, an action plate 326 and a bottom clamp plate 327. FIG. 6d shows a three-plate mold 410 for manufacturing a cap with a jump thread. The three-plate mold 410 is a European standard, four cavity mold and includes a top clamp plate 418, an X-plate 420, an A-plate 422, a B-plate 424, an action plate 426 and a bottom clamp plate 427. FIG. 6e shows a hot runner mold 510 for manufacturing a cap with a jump thread. The hot runner mold 510 is a European standard, four cavity mold and includes a top clamp plate 518, an hot runner plate 520, an A-plate 522, a B-plate 524, an action plate 526 and a bottom clamp plate 527. FIG. 6f shows a sub-gate mold 610 for manufacturing a cap with a jump thread. The sub-gate mold 610 is a European standard, four cavity mold and includes a top clamp plate 618, an A-plate 622, a B-plate 624, and a bottom clamp plate 627.

The resulting mold may then be identified by a catalog/part number, for example, the three plate mold 110 of FIG. 6a would be SM28-3PL-DT-4-DIN. This catalog/part number permits a user to quickly identify the critical characteristics of the tool.

Details of this invention will be described for a three plate mold 770 according to one embodiment of this invention. It should be understood that while details of the plates will be described for the three plate mold 770, a person having ordinary skill in the art will be able to create other mold configurations using the detailed description of the three plate mold 770 including the hot runner mold and the sub-gate mold.

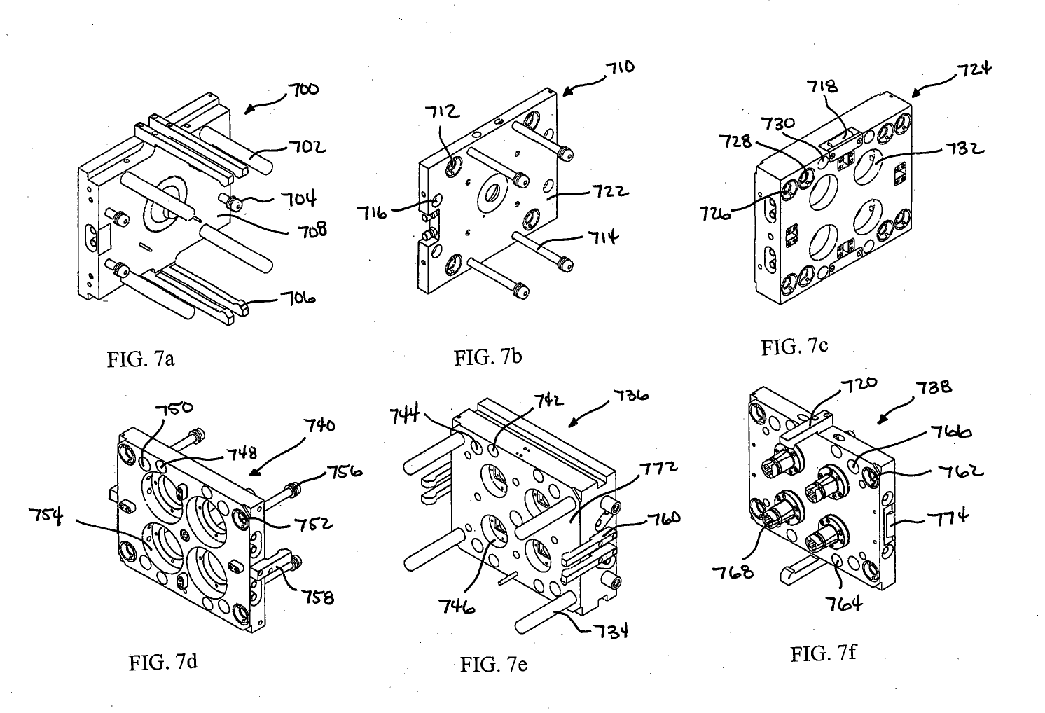

FIGS. 7a-f show individual plates of the three plate mold 770. The three plate mold in FIGS. 7a-f is a four cavity, European standard mold. Depending on the selected cavity inserts and/or core inserts, the plates shown in FIGS. 7a-e can be used to manufacture a cap of various shapes and sizes and with various coring styles including jump thread and dovetail. The plate shown in FIG. 7f is an action plate for manufacturing a cap with a dovetail thread.

FIG. 7a shows a top clamp plate 700 for the three plate mold 770. The top clamp plate 700 includes a plurality of top clamp plate posts 702, a plurality of top clamp plate pins 704 and a plurality of latch bars 706. In this embodiment, the plurality of top clamp posts extend perpendicularly from a surface 708 of the top clamp plate. The plurality of top clamp posts 702 align, at least some of, the plates of the three plate mold 770 in order consistently form a molded component. The top clamp plate pins 704 also extend perpendicularly from the surface 708 of the top clamp plate 708. The top clamp plate pins 704 allow another plate, in this case an X-plate 710, to move a limited distance from the surface 708 of the top clamp plate 700. This movement may assist in the formation of the molded component and/or the ejection of the molded component. The plurality of latch bars 706 are positioned on a side of the top clamp plate 700 and extend parallel to the top clamp plate posts 702. The latch bars 706 along with a wedge block 718 and a cam bar 720 form a locking device. The locking device provides a two-stage separation of plates to facilitate the ejection of one or more pieces formed in a closed mold position. A preferred locking device is described in U.S. Pat. No. 7,963,758, issued on 21 Jun. 2011, herein incorporated by reference for explanation of locking devices.

FIG. 7b shows the X-plate 710 according to one embodiment of this invention. The X-plate 710 includes a plurality of top clamp plate post receivers 712, a plurality of X-plate pins 714 and a top clamp plate pin receiver 716. Each of the top clamp post receivers 712 receive top clamp plate post 702 to maintain the alignment of the X-plate 710 to the top clamp plate 700. The plurality of X-plate pins 714 extend perpendicularly from a surface 722 of the X-plate 710. The X-plate pins allow another plate, in this case an A-plate 724, to move a limited distance from the surface 722 of the X-plate 710. This movement may assist in the formation of the molded component and/or the ejection of the molded component. The top clamp plate pin receiver 716 receives the top clamp plate pin 704.

FIG. 7c show the A-plate 724 according to one embodiment of this invention. The A-plate 724 includes a plurality of bottom clamp plate post receivers 726, a plurality of top clamp plate post receivers 728, a plurality of X-plate pin receivers 730 and a plurality of A-plate insert sockets 732. Each of the bottom clamp plate post receivers 726 receive a bottom clamp plate post 734 to maintain the alignment of a first mold half 700, 710, 724 to a second mold half 736, 738, 740 as the first mold half reciprocate relative to the second mold half. Each of the top clamp plate post receivers 728 receive the top clamp plate post 702 to maintain the alignment of the A-plate 724 to the top clamp plate 700. Each of the plurality of X-plate pin receivers 730 receives a respective X-plate pin 714. The plurality of A-plate insert sockets 732 may receive a cavity insert and/or a core insert for forming at least a portion of the molded component. Alternatively, each of the plurality of A-plate insert sockets 732 may operate to form a surface of the molded product without the cavity insert and/or the core insert.

FIG. 7d shows the B-plate 740 according to an embodiment of this invention. The B-plate 740 includes X-plate pin receivers 748, top clamp plate post receivers 750, bottom clamp plate post receivers 752, B-plate insert socket 754, B-plate pins 756 and B-plate cam bars 758. The X-plate pin receivers 748 receive a respective X-plate pin 714. Each of the bottom clamp plate post receivers 752 receive the bottom clamp plate post 734 and each the top clamp plate post receivers 750 receive the top clamp plate posts to maintain the alignment of the first mold half 700, 710, 724 and the second mold half 736, 738, 740 as the first mold half reciprocates relative to the second mold half. The plurality of B-plate insert sockets 754 may receive a cavity insert and/or a core insert for forming a portion of the molded component. Alternatively, each of the plurality of B-plate insert sockets 754 may form a surface of the molded product without the cavity insert and/or the core insert. The B-plate pins 756 allow the B-plate 740 to move a limited distance from a surface 7 of the bottom clamp plate 736.

FIG. 7e shows the bottom clamp plate 736 according to an embodiment of this invention. The bottom clamp plate includes the plurality of bottom clamp plate posts 734, a plurality of X-plate pin receivers 742, a plurality of B-plate pin receivers 744, a plurality of bottom clamp plate insert sockets 746 and a bottom clamp plate latch bars 760. The X-plate pin receivers 742 receive a respective X-plate pin 714. The B-plate pin receivers 744 receive a respective B-plate pin 756. The bottom clamp plate latch bars 760 along with a wedge block 774 and the B-plate cam bars 758 form a second locking device. The second locking device provides a two-stage separation of plates to facilitate the ejection of one or more pieces formed in the closed mold position. The plurality of bottom clamp plate insert sockets 732 may receive a cavity insert and/or a core insert for forming at least a portion of the molded component. Alternatively, the plurality of bottom clamp plate insert sockets 732 may provide access to a cavity insert and/or a core insert positioned on another plate, allowing for actuation of the cavity insert and/or the core insert positioned on another plate.

FIG. 7f shows the action plate 738 according to an embodiment of this invention. The action plate 738 includes bottom clamp plate post receivers 762, top clamp plate post receivers 764, B-plate pin receivers 766, the action plate cam bars 720 and a plurality of core inserts 768. The bottom clamp plate post receivers 762 receive the bottom clamp plate posts 734. The top clamp post receivers 764 receive the top clamp posts 702. The B-plate pin receivers 766 receive the B-plate pins 756. In this embodiment, the plurality of core inserts 768 are dovetail core inserts. In an alternative embodiment, the core inserts 768 can be any coring style.

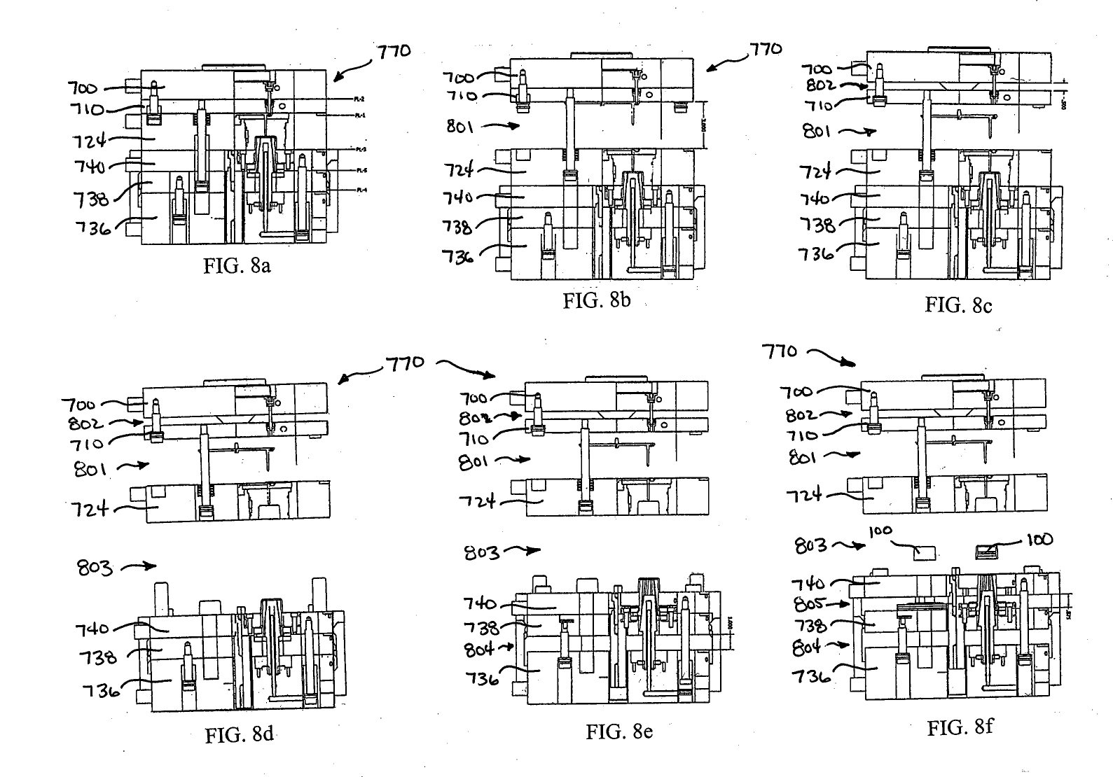

FIGS. 8a-f show an assembly view the three plate mold 770 of FIGS. 7a-f. The assembly view shows the various parting lines of the three plate mold 770. FIG. 8a shows the three plate mold 770 in the closed position. FIG. 8b shows the three plate mold 770 separated along a first parting line 801, between the X-plate 710 and the A-plate 724. FIG. 8c shows the three plate mold 770 separated along a second parting line 802, between the top clamp plate 700 and the X-plate 710. FIG. 8d shows the three plate mold 770 separated along a third parting line 803, between the A-plate 724 and the B-plate 740. The third parting line 803 also is the separation line between the first mold half 700, 710, 724 and the second mold half 736, 738, 740. FIG. 8e shows the three plate mold 770 separated along a fourth parting line 804, between the bottom clamp plate 736 and the action plate 738. FIG. 8f shows the three plate mold 770 separated along a fifth parting line 805, between the B-plate 740 and the action plate 738.

Additionally, as shown in FIG. 1, the mold system of this invention preferably includes a performance monitoring tool 40 such as an electronic mold counter as described in U.S. Ser. No. 12/818,684 that is hereby incorporated by reference. Generally speaking, a plastic injection mold as described is preferably provided with a monitor, which is actuated with each opening and closing cycle of the mold to maintain a count of the operating cycles performed, as well as additional information about the mold and its operation. This information is maintained or associated with the monitor in the mold, whether the mold is on the press or a storage rack, and may be retrieved remotely or directly from the monitor. The monitor according to this invention preferably tracks one or more of the following sets of information: Total Cycles; Total Time; Active (Up) Time; Idle Time; Idle Time Total; Active (Up) Time Average; Sleep Time; Sleep Time Total; Cycle Time; Average Cycle Life to Date; Average Cycle Recent; Activity Percentage; Activity Percentage Recent; Resettable Trip Count; Down Days; Days Initiated; Battery Level; Segment Time; Device ID; Mold ID; and/or PM Cycles. Such information may then be stored, analyzed, compiled and otherwise used within the system as described for maintenance, performance analysis, inventory and otherwise.

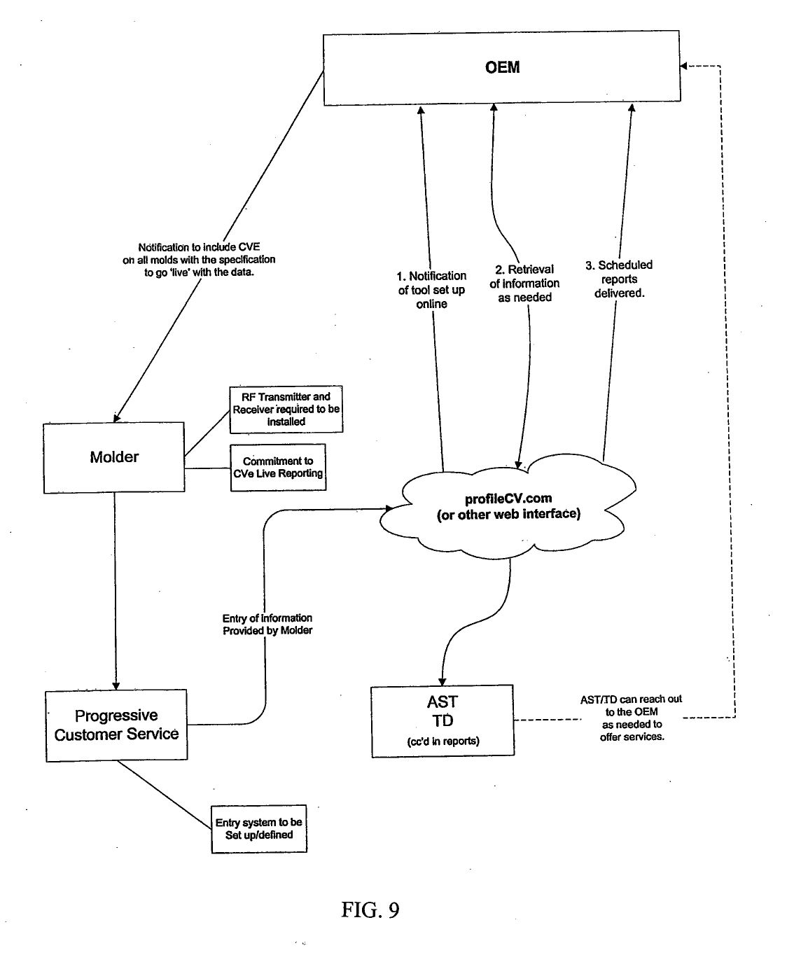

FIG. 9 shows a schematic of the interplay among an electronic mold counter (“CVE”), the mold system as described herein, a molder and an original equipment manufacturer (“OEM”). As a result of the described system, the OEM may specify that the CVE be included in all molds built by the molder. The molder can then specify a mold as described herein and the OEM can then receive manufacturing and maintenance reports remotely and as needed without direct physical involvement or oversight.

The system according to the subject invention permits cycle times to be scrutinized and, when necessary, troubleshooting may be provided remotely and/or on-site. Mold maintenance assessments and support may also be offered remotely and/or on-site. In this manner, a manufacturer can obtain molding oversight, first article review, live, realtime, monitoring of the manufacturing process and a standardized maintenance plan using an off-the-shelf customizable mold system. As a result of the options described above, a user may test the viability of, for instance, a dovetail coring style with an 1 to 4 cavity tool, prove out savings over existing unscrewing molds and then commit to a higher cavitation base and still utilize all the system manufacturing benefits.

Thus, the invention provides a system for creating custom molds that leverages basic designs and common components to create an off the shelf mold.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A customizable mold system comprising:
a first mold half including a top clamp plate and an A-plate, the top clamp plate including a top clamp plate post extending perpendicular from a surface of the top clamp plate and the A-plate includes an A-plate top clamp plate post receiver for receiving the top clamp post;
a second mold half including a bottom clamp plate and a B-plate, the bottom clamp plate including a bottom plate post extending perpendicular from a surface of the bottom clamp plate and the B-plate includes a B-plate bottom clamp post receiver for receiving the bottom clamp plate;
wherein the first mold half and the second mold half reciprocate from an open position to a closed position and wherein in the closed position the A-plate contacts the B-plate; and
wherein the top clamp plate, the A-plate, the B-plate and the bottom clamp plate are selectable from a pre-engineered kit-style mold system with a plurality of gating options, a plurality of coring options, a plurality of mold base types and a plurality of cavitation options.

2. The customizable mold system of claim 1 further comprising:
a cavity insert positioned in one of an A-plate insert socket and a B-plate insert socket; and
a core insert positioned in one of the A-plate insert socket and the B-plate insert socket.

3. The customizable mold system of claim 1 further comprising:
an X-plate positioned between the top clamp plate and the A-plate.

4. The customizable mold system of claim 1 further comprising:
an action plate positioned between the B-plate and the bottom clamp plate.

5. The customizable mold system of claim 1 further comprising:
a hot-runner plate positioned between the top-clamp plate and the A-plate.

6. The customizable mold system of claim 5 further comprising:
an action plate positioned between the B-plate and the bottom clamp plate.

7. The customizable mold system of claim 1, wherein the plurality of gating options include a three plate, a hot runner and a sub-gate.

8. The customizable mold system of claim 7, wherein the hot runner further includes a valve gate option and a top gate option.

9. The customizable mold system of claim 1, wherein the plurality of coring options include a dovetail, a jump thread and an unscrewing core method.

10. The customizable mold system of claim 1, wherein the plurality of mold base types include a European standard (DIN), a U.S. standard and a Japanese standard (JIS).

11. The customizable mold system of claim 1, wherein the plurality cavitation options include a four cavity option, an eight cavity option, a sixteen cavity option and a twenty-four cavity option.

12. A method of creating a mold comprising:
selecting a top clamp plate from a plurality of top clamp plates, each of the plurality of top clamp plates including a top clamp plate post extending perpendicular from a surface of a respective top clamp plate;
selecting an A-plate from a plurality of A-plates, each of the A-plates including an A-plate top clamp plate post receiver to couple with the top clamp plate post;
selecting a bottom clamp plate from a plurality of bottom clamp plates, each of the plurality of the bottom clamp plates including a bottom clamp plate post extending perpendicular from a surface of a respective bottom clamp plate;
selecting a B-plate from a plurality of B-plates, wherein each of the B-plates includes a B-plate bottom clamp plate post receiver to couple with the bottom clamp plate post;
wherein a selected top clamp plate and a selected A-plate form a top mold half and a selected bottom clamp plate and a selected B-plate form a bottom mold half;
wherein the top mold half and the bottom mold half reciprocate from a closed position to an open position, in the closed position the selected A-plate contacts the selected B-plate; and
wherein the mold is customized through the selection of the top clamp plate, the A-plate, the B-plate and the bottom clamp plate to provide various options including a gating option, a core type, a mold base standard and a number of cavities.

13. The method of claim 12 further comprising:
selecting an X-plate from a plurality of X-plates, wherein a selected X-plate is positioned between the selected top clamp plate and the selected A-plate.

14. The method of claim 12 further comprising:
selecting an action plate from a plurality of action plates, wherein a selected action plates is positioned between the selected B-plate and the selected bottom clamp plate.

15. The method of claim 12 further comprising:
selecting an hot runner plate from a plurality of hot runner plates, wherein a selected hot runner plate is positioned between the selected top clamp plate and the selected A-plate.

16. The method of claim 12, wherein the gating options include a three plate, a hot runner and a sub-gate.

17. The method of claim 16, wherein the hot runner further includes a valve gate option and a top gate option.

18. The method of claim 12, wherein the core types include a dovetail, a jump thread and an unscrewing thread.

19. The method of claim 12, wherein the mold base standards include a European standard, a U.S. standard and a Japanese standard.

20. The method of claim 12, wherein the plurality cavitation options include a four cavity option, an eight cavity option, a sixteen cavity option and a twenty-four cavity option.
